(19) United States
(12) Patent Application Publication
(10) Pub. No.: US 2020/0294269 A1
(43) Pub. Date: Sep. 17, 2020

(54) CALIBRATING CAMERAS AND COMPUTING POINT PROJECTIONS USING NON-CENTRAL CAMERA MODEL INVOLVING AXIAL VIEWPOINT SHIFT

(71) Applicant: INTEL CORPORATION, Santa Clara, CA (US)

(72) Inventor: Radka Tezaur, Union City, CA (US)

(73) Assignee: INTEL CORPORATION, SANTA CLARA, CA (US)

(21) Appl. No.: 16/886,512

(22) Filed: May 28, 2020

(51) Int. Cl. G06T 7/80; G06T 7/73; G06T 5/00

(52) U.S. Cl. CPC G06T 7/80; G06T 2207/30252; G06T 5/006; G06T 7/73

(57) ABSTRACT

An example system for identification of three-dimensional points includes a receiver to receive coordinates of a two-dimensional point in an image, and a set of calibration parameters. The system also includes a 2D-to-3D point identifier to identify a three-dimensional point in a scene corresponding to the 2D point using the calibration parameters and a non-central camera model including an axial viewpoint shift function comprising a function of a radius of a projected point in an ideal image plane.

### BACKGROUND

Wide-angle lenses may be used to capture images with more of a scene included than possible using other types of lenses. A wide-angle lens refers to a lens whose focal length is smaller than the focal length of a normal lens for a given film plane. For example, for a full-frame 35 mm camera with a 36 mm by 24 mm format, the diagonal measures 43.3 mm and by custom, the normal lens adopted by most manufacturers is 50 mm. A lens of focal length 35 mm or less on a full-frame 35 mm camera may therefore be considered wide-angle. Fisheye lenses are ultra-wide-angle lenses that have focal lengths of 15 mm or less on a full-frame 35 mm camera. Fisheye lenses may have FOVs of up to 180 degrees or more.

### BRIEF DESCRIPTION OF THE DRAWINGS

FIG. 1 is a block diagram illustrating an example system for calibrating and computing point projections for cameras using a non-central camera model;

FIG. 2 is a fisheye image;

FIG. 3 is an illustration of the projection of the fisheye image;

FIG. 4 is an illustration a checkerboard template;

FIG. 5A is a diagram illustrating an example fisheye camera with ray tracing shown for a ray of five degrees;

FIG. 5B is a diagram illustrating an example fisheye camera with ray tracing shown for a ray of 85 degrees;

FIG. 6 is a process flow diagram illustrating a method for calibrating parameters of a non-central camera model augmented with viewpoint shift;

FIG. 7 is a process flow diagram illustrating a method for computing a 3D-to-2D point projection using a non-central camera model augmented with viewpoint shift;

FIG. 8 is a process flow diagram illustrating a method for computing a 2D-to-3D point identification using a non-central camera model augmented with viewpoint shift;

FIG. 9A is a block diagram illustrating an example computing device that can calibrate and compute point projections for cameras using a non-central camera model augmented with axial viewpoint shift;

FIG. 9B is a block diagram illustrating an example computing device that can compute 3D-to-2D point projections and 2D-to-3D point identifications using a non-central camera model augmented with axial viewpoint shift;

FIG. 10 is a block diagram showing computer readable media that store code for calibrating and computing point projections for cameras using a non-central camera model augmented with viewpoint shift; and

FIG. 11 is an illustration of vehicles with fisheye cameras.

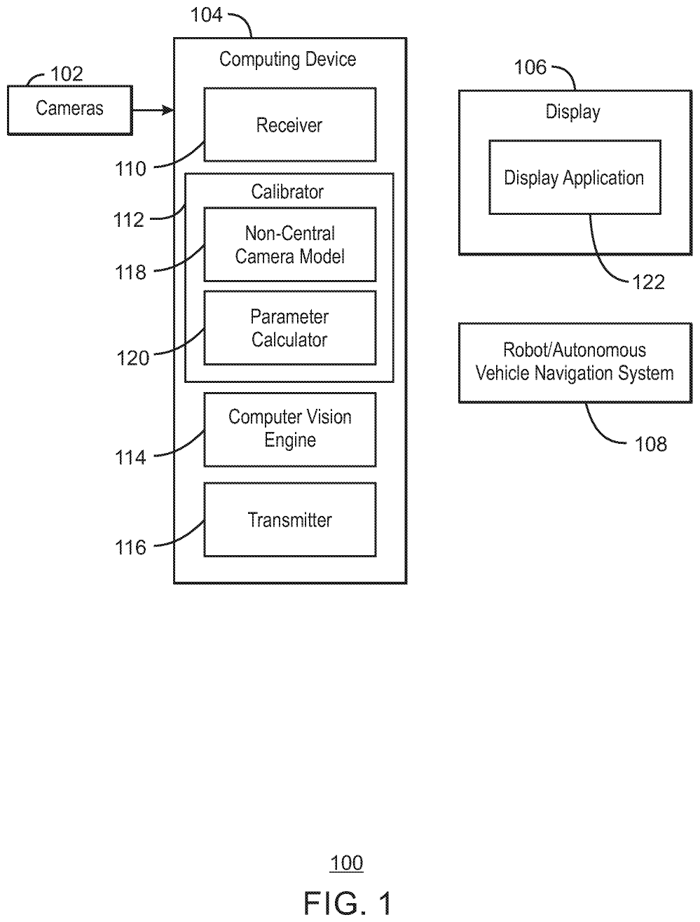

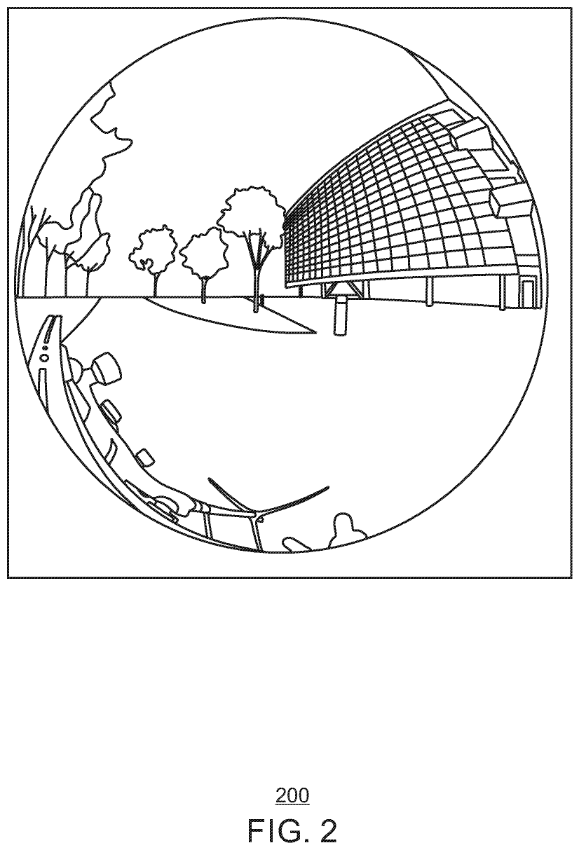

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Computer vision and computational imaging applications may map points in captured two-dimensional (2D) images to light rays or points in the three-dimensional (3D) world and vice versa with high degree of accuracy. In order to be able to do that, the camera-lens system may first be calibrated. However, received system design parameters may not describe real system behavior with enough precision due to manufacturing tolerances and other factors. Thus, calibration may involve the use of either images captured with the particular camera or some other kind of measurements involving the actual camera for accurate enough characterization.

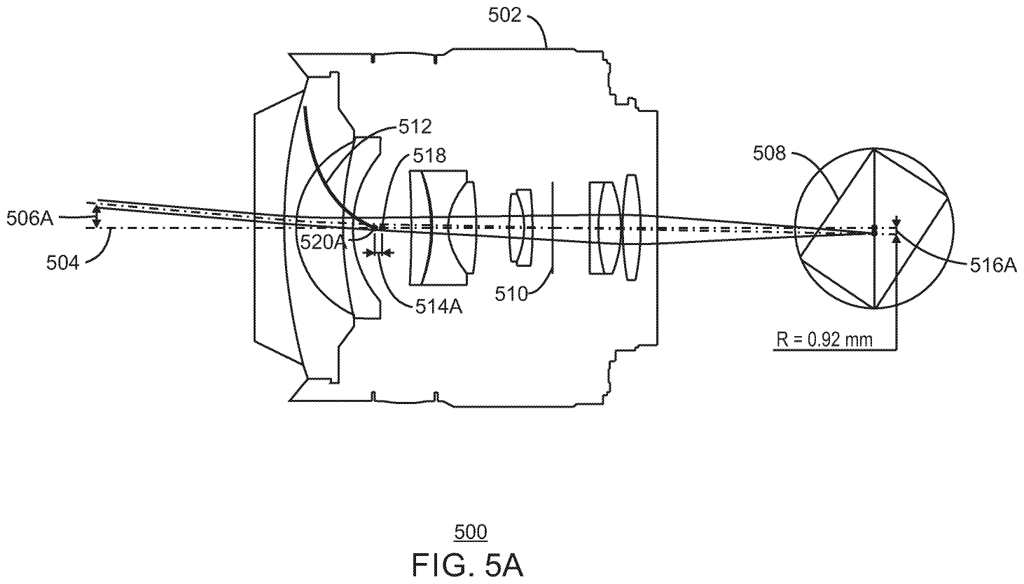

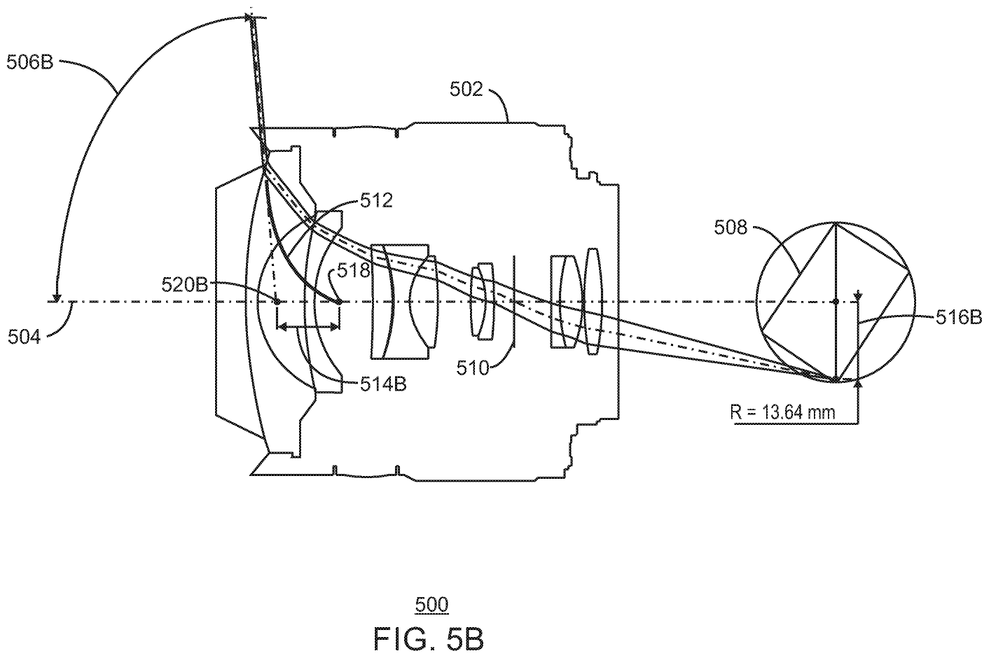

In order to correct for various types of lens distortion, lenses may be modeled and the resulting model used to calibrate the particular lens type. However, models and algorithms used for the calibration of regular cameras may be generally unsuitable for wide-angle cameras such as fisheye cameras or omnidirectional cameras. For example, such models may not be able to handle the field of view that is close to or exceeds 180°. In particular, such models may represent a scene as a plane or use the concept of planar undistorted image that covers the whole FOV, which is not possible when the FOV is close to or exceeds 180 degrees. For example, many of the existing fisheye models assume that the projection from 3D to 2D performed by a camera equipped with a fisheye lens is a central projection. A central projection assumes that there exists a single viewpoint through which all the rays forming the image are passing. However, in practice, the entrance pupil of a lens with an extremely large field of view tends to move and the axial viewpoint shifts with the incident angle of the rays. In practice, the design of many wide angle lenses as analyzed using ray tracing reveals that non-central characteristics may be quite strong. Generally, a non-central model assumes that there are multiple viewpoints through which the rays forming the image are passing. For example, the viewpoints may depend on the incident angle of the rays as described in FIGS. 5A and 5B. The non-central camera model described herein may characterize the distance between the viewpoints that depends on the incident angle. This distance is referred to as an axial viewpoint shift. This axial viewpoint shift may be particularly noticeable in wide angle lenses having a field of view close to or greater than 180 degrees. For example, rays coming from an angle closer to 90 degrees relative to the optical axis may result in a significant shift between a real viewpoint where the chief ray with a particular incident angle intersects the optical axis and an assumed viewpoint of a central projection model. This viewpoint shift may also be particularly noticeable in images of closer objects. Neglecting this viewpoint shift may make computations much simpler, but may lead to large errors for objects near the camera which can severely limit the performance of the system. For example, in some camera arrays, the disparity (depth) estimation may start to break down for objects closer than 1.6 meters. In various examples, such viewpoint shift may result in errors in the magnitude of tens of pixels that may accordingly affect various computer vision applications. For example, a ray tracing analysis of a set of fisheye lenses indicated that an axial viewpoint shift between 0° and 90° incident angle exceeded 1 cm. In particular, the axial viewpoint shift measured at 10.8 mm and 12.2 mm. In the case of an object placed 0.5 m from the camera at 90° angle, neglecting a one centimeter viewpoint shift results in more than 1° error in the assumed ray direction. With a large resolution camera, this viewpoint shift may translate to an error in order of tens of pixels. For example, in 360° camera arrays that use very high resolution sensors providing angular resolution of about 35 pixels per degree and thus, an error of more than 40 pixels might occur with a similar viewpoint shift.

Moreover, existing non-central models may be difficult to use. In particular, obtaining calibration using existing non-central models may require the knowledge of detailed camera specifications that may be hard or even impossible to obtain.

The present disclosure relates generally to cameras. Specifically, the techniques described herein include an apparatus, method and system for calibrating model parameters of a non-central camera model augmented with an axial viewpoint shift. In particular, the axial viewpoint shift is calculated as a function of the radial distance from the principal point in a fisheye image rather than a function of the incident angle. An example system includes a receiver to receive a number of images from a camera. The system also includes a 2D-to-3D point identifier to identify a three-dimensional point in a scene corresponding to the 2D point using the calibration parameters and a non-central camera model including an axial viewpoint shift function comprising a function of a radius of a projected point in an ideal image plane. In some examples, the system includes a 3D-to-2D projector to compute a projection of points in a three-dimensional (3D) space to a two-dimensional (2D) image using a non-central camera model that includes an axial viewpoint shift function that is a function of the radius of the projected point in an ideal image plane.

The techniques described herein thus enable adaption of existing algorithms, software, or devices to include the viewpoint shift and improve their accuracy for close range objects. For example, the techniques described herein may be used as an extension of existing central projection models and corresponding camera modeling tools. Such an extension implementation enables adapting algorithms and the open source code that implements them to perform non-central projection and thus create tools that can accurately characterize fisheye cameras. The more accurate extended tools that include the inherent incident angle dependent viewpoint shift may be easier to use than other comparable tools. For example, a simple to use calibration package can be produced with the wide-eye camera model described herein, as the similar algorithm for automatic initialization of calibration parameters can be applied without the use of any detailed camera and lens design specifications that may be hard or impossible to obtain for a user. The techniques also enable a more accurate 3D to 2D projection of points to fisheye images or other wide-angle images by including the axial viewpoint shift without any increase in processing complexity.

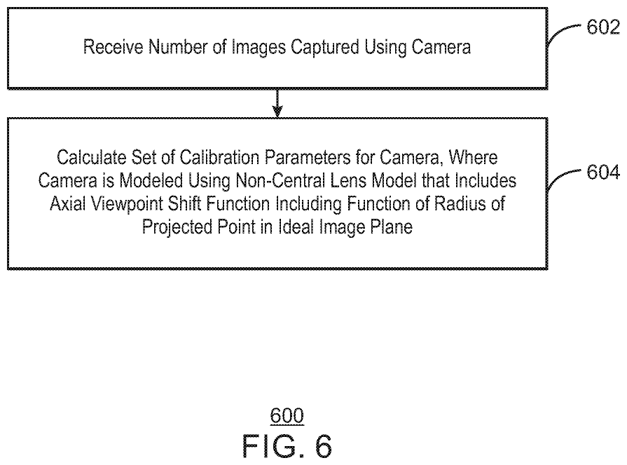

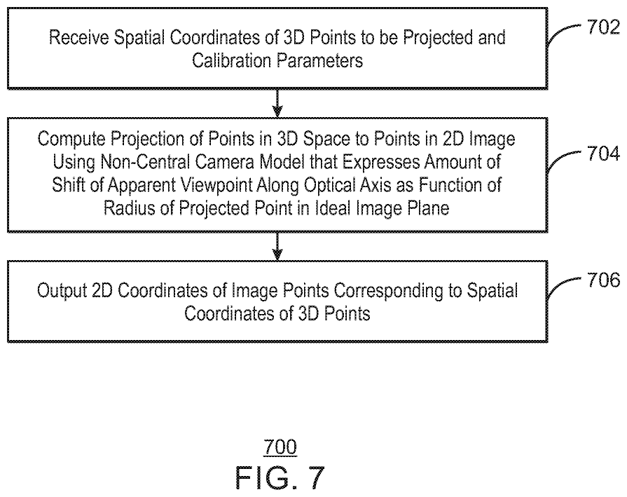

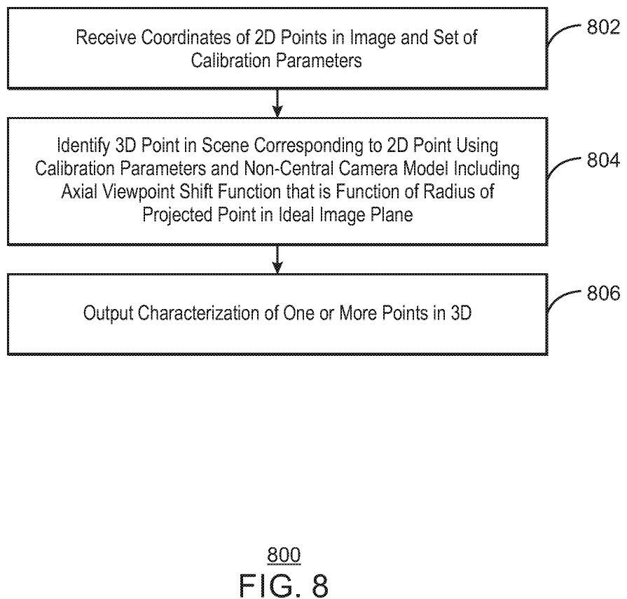

FIG. 1 is a block diagram illustrating an example system for calibrating and computing point projections for cameras using a non-central camera model. The example system 100 can be implemented in the computing device 800 in FIG. 8 using the methods 600 and 700 of FIGS. 6 and 7.

The example system 100 includes a number of cameras 102, a computing device 104, a display 106, and a robot/autonomous vehicle navigation 108. The computing device 104 includes a receiver 110, a calibrator 112, a computer vision engine 114, and a transmitter 116. The calibrator 112 includes a non-central camera model 118 and a parameter calculator 120. The display 106 includes a display application 122.

As shown in FIG. 1, a number of cameras 102 may capture images or video. For example, the cameras 102 may be a camera array. In some examples, each camera may be a fisheye camera. As used herein, a fisheye camera is a camera that includes a fisheye lens that produces strong visual distortion intended to create a wide panoramic or hemispherical image. In various examples, the cameras 102 may be a single omnidirectional camera. As used herein, an omnidirectional camera is a camera with a field of view approaching or larger than 180 degrees. In some examples, the cameras 102 may be catadioptric cameras. For example, catadioptric cameras may include an optical system that involves both the reflecting and refracting of light. Each of the cameras 102 may capture an image such as the image 200 of FIG. 2.

In some examples, one or more cameras 102 can feed calibration images to the calibrator 112. In various examples, the calibrator 112 is communicatively coupled to the computer vision engine 114 or a computational imaging engine (not shown), which in turn is connected to display application 112, or robot/autonomous vehicle navigation system 108, or some other end user application (not shown). In various examples, the calibrator 112 produces the calibration parameters. For example, the calibration parameters may include non-central camera model coefficients and other camera intrinsic parameters, extrinsic parameters that describe the position of the camera with respect to a fixed frame of reference, and, in the case of multiple cameras 102, may also include the extrinsic parameters that characterize their mutual position. In some examples, the non-central camera model coefficients are fed to a separate system that involves cameras that have been calibrated, a computing device that hosts the application that processes the captured images, and possibly also a display 106. The display 106, however, is optional, as the fisheye images can be used, for example, for robot/autonomous vehicle navigation 108, in which case the calibration parameters are not used to produce some rectified or combined images to display. Instead, in some examples, the calibration parameters may be used to determine the position of the robot or vehicle and other objects in a scene. Thus, the calibration parameters can be used to determine the position of a robot or vehicle including the computing device 104. The computing device 104 may also be used to determine the position of objects within the scene in real time.

In various examples, as in the case of dynamic calibration, when the images that are to be processed are also used for the calibration, the calibrator and the application that uses the calibration may reside within the same computing device 104, to which a display 106 may or may not be attached. Similarly, as above, the goal may not be to produce some images that need to be displayed, but, for example, to determine the spatial position of objects in the scene and use the spatial position for navigation.

The computing device 104 may receive images from the cameras 102 and calibration parameters described herein. The receiver 108 may receive the number of images and send the number of images to a calibrator 112. The calibrator 112 may include a non-central camera model 118 and a parameter calculator 120. The non-central camera model 118 may be a camera model that includes an axial viewpoint shift as described below. In various examples, the non-central camera model includes a radial distortion polynomial and a viewpoint shift polynomial. An overall camera model may include both the non-central camera model and the image sensor model. For example, the image sensor model may be a projective transform. Further, as described below, the non-central camera model 118 can be used by the computer vision engine 114 to project points from as 3D space to the 2D fisheye image for various computer vision tasks. In various examples, the radial distortion function ƒ(ρ) and the viewpoint shift function g(ρ) described below are used whenever a point is to be projected from the 3D space to the 2D fisheye image. The radial distortion polynomial ƒ(ρ) characterizes radial distortion of a fisheye lens similar to that used in a conventional fisheye model. In various examples, the radial distortion function ƒ(ρ) and the viewpoint shift function g(ρ) described below can also be used to identify an incident ray or some point in the 3D scene corresponding to a given point in the 2D fisheye image. In some examples, the radial distortion function ƒ(ρ) and the viewpoint shift function g(ρ) described below are polynomials used to describe the non-central camera model are approximations of the real lens properties.

The parameter calculator 120 may calculate any parameters to be applied to a model of the fisheye camera. Intrinsic parameters may include the parameters intrinsic to the camera itself, such as parameters related to sensor geometry and alignment, lens distortion parameters, and viewpoint shift parameters. In some examples, a six-parameter projective transform may be used to accurately model the projection onto a tilted sensor. In various examples, a checkerboard may be used to perform intrinsic calibration. The parameter calculator 120 may also calculate extrinsic parameters such as rotation and translation of a calibration chart with respect to the fisheye camera for each calibration image. In various examples, an automatic initial estimate for the calibration parameters may be based on a mapping from the captured image coordinates to the ideal image plane that includes only shifting the origin of the coordinate system to the center of the image. The remaining intrinsic parameters may then be estimated. For example, the remaining intrinsic parameters may include the coefficients of the polynomials ƒ and g that characterize the radial distortion of the lens and the viewpoint shift, respectively. In various examples, the rotation and translation between the camera and each calibration chart position may also be estimated to estimate these remaining intrinsic parameters. In some examples, the accuracy of this initial estimate can also be improved by splitting the intrinsic and extrinsic parameters into several groups and estimating the parameter values iteratively in an alternating fashion, computing better values for the parameters in one of the groups while keeping all the remaining parameters fixed, as described below.

Thus, the parameter calculator 120 may be used to calibrate the non-central camera model 118. In various examples, the estimated parameters may serve as a starting point for an iterative non-linear optimization, minimizing some appropriate cost function. For example, the cost function may be a mean square reprojection error, or a reprojection error modified to reduce the impact of outliers.

In various examples, the computer vision engine 114 can perform one or more computer vision tasks based on the calibration parameters from the calibrator 112. For example, the computer vision engine 114 can receive images from the cameras 102 and calibration parameters from the calibrator 112, and uses this input together with some algorithms that make use of the camera model to perform various computer vision tasks. For example, the computer vision tasks may include synthesizing other images such as projections, creating a 3D map of a scene that can be used for navigation, detecting and classifying objects in the scene, etc.

The transmitter 116 can transmit the calibration parameters from the calibrator 112 and images from the computer vision engine 114. For example, the transmitter 116 can transmit some output images to the display 106. In some examples, the transmitter 116 can help to control a device such as a robot, a drone, or a car, by transmitting calibration parameters and images for robot/autonomous vehicle navigation system 108. In various examples, the transmitter 116 can transmit additional forms of information, such as object type labels, bounding box sizes and positions, among other forms of information, for use by the display application 122, the robot/autonomous vehicle navigation 108 or some other device or application.

In some examples, a robot or autonomous vehicle navigation system 108 includes the computing device 104. In such examples, the non-central camera model 118 and the output of the parameter calculator 120 may be used to derive the position of objects in a scene. The non-central camera model 118 and the output of the parameter calculator 120 may also be used to derive the position of the robot or autonomous vehicle system within an environment.

As one example of system 100, the output images from several cameras 102 forming a camera array may be combined to create either a 3D representation of the scene or an image without distortion. In this example, the image can look like an image taken with a normal camera from a different position. As another example, the system 100 may including at least one moving camera 102 and can produce a 3D map of a scene. For example, the 3D map maybe produced using any suitable simultaneous localization and mapping (SLAM) techniques.

The diagram of FIG. 1 is not intended to indicate that the example system 100 is to include all of the components shown in FIG. 1. Rather, the example system 100 can be implemented using fewer or additional components not illustrated in FIG. 1 (e.g., additional cameras, computing devices, calibrators, computer vision engines, displays, robots, autonomous vehicles, etc.). For example, the computer vision engine 114 may be located on another device than computing device 104. In some examples, the system 100 may include multiple computer vision engines 114. In some examples, the calibrator 112 may be part of the robot/autonomous vehicle navigation system 108.

FIG. 2 is a fisheye image. The fisheye image 200 may be generated using a fisheye camera, such as the camera 102 of FIG. 1. As shown in FIG. 2, the fisheye image 200 shows considerable lens distortion. In particular, the fisheye image 200 has a convex non-rectilinear appearance.

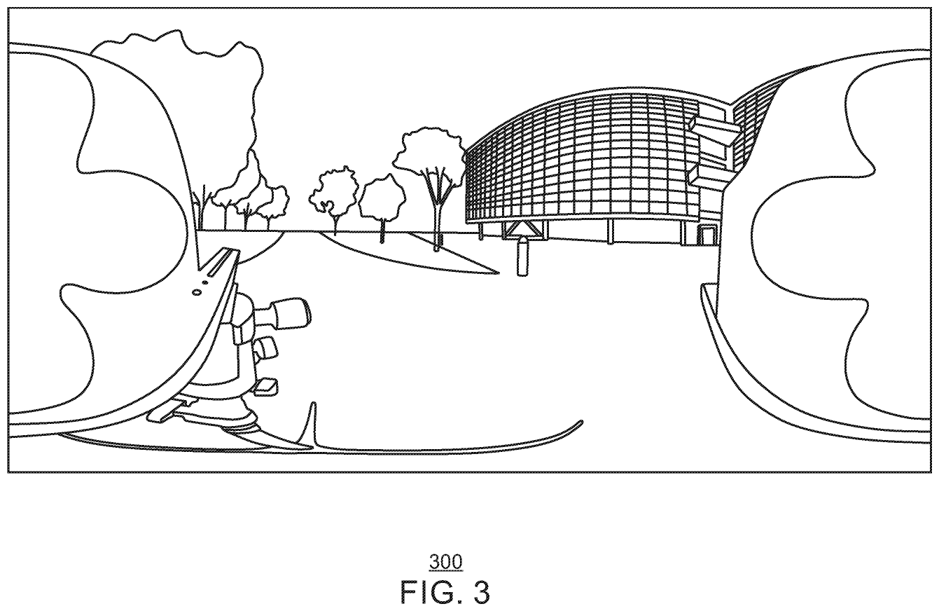

FIG. 3 is an illustration of the projection of the fisheye image. The projection 300 is a projection of the fisheye image 200 of FIG. 2. In various examples, the image 300 is computed by the display application 122 of FIG. 1 using the images captured by the cameras 102. As shown in FIG. 3, the distortion present in the image of FIG. 2 has been removed. In particular, the projection 300 of FIG. 3 is a rectilinear image that has straight lines of perspective.

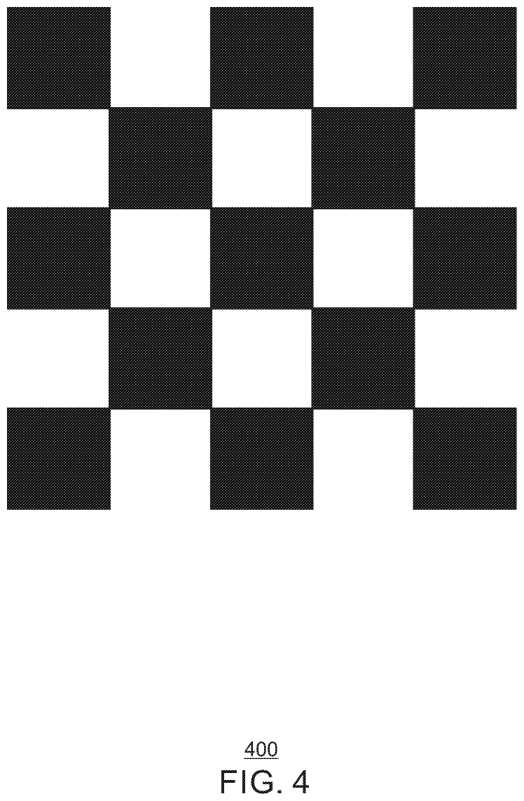

FIG. 4 is an illustration a checkerboard template. The checkerboard template 400 includes a checkerboard pattern of alternating black and white boxes.

In some examples, the checkerboard pattern may have an inverted pattern of alternating black and white boxes. In various examples, the checkerboard template 400 may be used for calibration of model parameters as described herein. In addition, while a checkerboard calibration chart has been illustrated, some embodiments may not use images of checkerboard calibration chart. For example, other implementations may use images of a different chart or a special calibration device, or they could use general images that do not include any calibration chart or special devices. For example, the special devices may include a calibration wand with light-emitting diodes (LEDs). Thus, offline calibration may be performed via a general calibration chart or another device, such as a calibration device. In addition, the non-central camera model described herein could be used, for example, for a dynamic calibration implementation. The dynamic calibration implementation may directly use the fisheye images to be processed by some application. Thus, the present techniques include an off-line calibration (e.g. with the checkerboard) and a dynamic calibration case.

FIG. 5A is a block diagram illustrating an example fisheye camera 500 with ray tracing shown for a ray of five degrees. The example fisheye camera 500 can be implemented in the computing device 800 of FIG. 8. For example, the fisheye camera 500 can be one of the cameras 827. The fisheye camera 500 may be modeled and calibrated using the method 700 of FIG. 7.

The example fisheye camera 500 may be part of a camera array (not shown). The fisheye camera 500 includes a fisheye lens 502 including a number of lens elements. For example, the lens elements may include various pieces of optical glass honed into spherical or aspherical shapes. The fisheye lens 502 has an optical axis 504 indicated by a solid line. FIG. 5A includes a ray tracing of a ray of light through the fisheye lens 502 with an angle theta 506A representing an angle of the incoming light ray with respect to the optical axis 504. In the example of FIG. 5A, the value of angle theta 506A is five degrees. The fisheye camera 500 also includes a sensor 508. The sensor 508 of FIG. 5A is a 15.8×23.6 millimeter (mm) sensor. In various examples, the sensor may be a 24×36 mm sensor, or any other suitable sensor. The fisheye lens 502 includes an adjustable diaphragm 510 that provides an aperture stop for the fisheye lens 502. In the example of FIG. 5A, the aperture stop is set at an f-number of f/8. FIG. 5A also shows a shift line of entrance pupil 512. A viewpoint shift 514A is associated with a radial distance 516A. For example, the viewpoint shift 514A indicates a distance between a viewpoint 518 for a zero incident angle and a viewpoint 520A for incident angle 506A. The viewpoints 518 and 520A are projection centers.

As shown in the example of FIG. 5A, a smaller incident angle 506A is associated with both a smaller radial distance 516A and a smaller viewpoint shift 514A as measured from the viewpoint 518 for zero incident angle. For the example lens 502 of FIG. 5, the incident angle 506A of five degrees is associated with a radial distance R 516A of 0.92 mm. The radial distance R 516A may be the distance between the center of the image where the optical axis 504 meets the sensor 508 and the image point in the ideal image plane perpendicular to the optical axis. In various examples, as described in the viewpoint shift polynomial g(ρ) of Eqn. 6 below, the viewpoint shift 514A is expressed as a function of the radial distance 516A.

The diagram of FIG. 5A is not intended to indicate that the example fisheye lens 500 is to include all of the components shown in FIG. 5A. Rather, the example fisheye lens 500 can be implemented using fewer or additional components not illustrated in FIG. 5A (e.g., additional lens elements, sensors, values for angle theta, etc.). In addition, in some examples, the viewpoint shift may shift from left to right, rather than right to left, as the incident angle increases. For example, this may include ultra-wide-angle rectilinear lenses.

FIG. 5B is a block diagram illustrating an example fisheye lens 500 with ray tracing shown for a ray of 85 degrees. The example fisheye lens 500 can be implemented in the computing device 800 of FIG. 8. For example, the fisheye lens 500 can be included in the camera 826. The fisheye lens 500 may be modeled and calibrated using the method 700 of FIG. 7.

The example fisheye lens 500 includes similarly numbered elements described with respect to FIG. 5A. However, the example diagram in FIG. 5B of fisheye lens 500 shows a ray tracing with a ray of light with a theta angle of 85 degrees with respect to the optical axis 504.

In the example of FIG. 5B, the incoming light ray with angle theta 506B of 85 degrees results in a larger axial viewpoint shift 514B between the viewpoint 518 for the zero incident angle and a more shifted viewpoint 520B for incident angle 506B. The larger distance 514B is associated with a larger radial distance 516B of 13.64 mm from the center of the sensor 508. In various examples, the viewpoint shift polynomial g(ρ) may express the viewpoint shift 514B as a function of the radial distance 516B.

The diagram of FIG. 5B is not intended to indicate that the example fisheye lens 500 is to include all of the components shown in FIG. 5B. Rather, the example fisheye lens 500 can be implemented using fewer or additional components not illustrated in FIG. 5B (e.g., additional lens elements, sensors, values for angle theta, etc.).

In some fisheye calibration tools, nine intrinsic parameters may be used to characterize a camera equipped with a fisheye lens. Five of the parameters specify an affine transform from the ideal image plane to the sensor (or captured image) pixel coordinate system. The remaining four parameters determine a polynomial that characterizes the radial distortion of the lens. For example, the radial distortion polynomial may be represented by the equation:

ƒ(ρ)=ƒ₀+ƒ₂ρ²+ƒ₃ρ³+ƒ₄ρ⁴ Eqn. 1

For any given point (x,y) in the ideal image plane corresponding to some point in the captured image, Eqn. 1 specifies the corresponding ray in 3D which gets projected to (x,y) by the fisheye lens, providing a point in 3D space that lies on the ray. The coordinates of this point in 3D are (x, y, ƒ(ρ)), where ρ=\sqrt{x²+y²}. The coordinate system used here is the camera coordinate system, in which the x and y directions are the horizontal and vertical direction in the image plane, respectively, z is the direction of the camera optical axis, and the origin of the coordinate system is at the optical center of the lens.

In various examples, a different model may be used instead of the model based on Eqn. 1. For example, instead of the five-parameter affine transform in which one parameter is redundant, a non-redundant six-parameter projective transform may be used as the mapping from the ideal image plane to the sensor pixel array. The model using the non-redundant six-parameter projective transform provides a more physically accurate model for a sensor slightly tilted with respect to the lens optical axis. In addition to replacing the redundant affine transform parameterization by a non-redundant projective transform parameterization, a different radial distortion polynomial may be used. For example, the updated radial distortion polynomial ƒ(ρ) used may be represented by the equation:

ƒ(ρ)=ƒ₀+ƒ₁ρ²+ƒ₂ρ⁴+ƒ₃ρ⁶ Eqn. 2

More generally, the updated polynomial ƒ(ρ) may be represented using the equation:

ƒ(ρ)=Σₘ₌₀^{M}ƒₘρ^{2m} Eqn. 3

As shown in Eqn. 2, in various examples, the omission of the linear term in Eqn. 1 can be extended to all odd terms. Considering the cross-section of the lens with the plane x=0, ƒ(y) may be an even function, due to the radial symmetry of the lens, and ƒ(y) may be smooth everywhere, including at y=0. To extend Eqns. 1-3 to a non-central fisheye projection, a second polynomial, referred to herein as a viewpoint shift polynomial, may be introduced that characterizes the amount of viewpoint shift along the optical axis of the lens. In the original central model, all the points in 3D space that get projected to a point (x,y) in the ideal image plane may be assumed to form the half-line formed by all points:

d(x,y,ƒ(ρ)),d>0 Eqn. 4

with all the rays passing through the origin. However, in an updated model, these points may form a half-line formed by all the points:

(0,0,g(ρ))+d(x,y,ƒ(ρ)),d>0 Eqn. 5

where the ray that gets projected to point (x,y) at the radius ρ=\sqrt{x²+y²} passes through the point (0, 0, g(ρ)) on the optical axis. To eliminate redundant parameters, g(0)=0. Also, for similar reasons in the case of the lens distortion polynomial, the viewpoint shift polynomial g(ρ) may also be an even function. Therefore, the viewpoint shift polynomial may be described using the equation:

g(ρ)=Σₖ₌₁^{K}gₖρ^{2k} Eqn. 6

where the shift of the axial viewpoint along the optical axis is expressed as the function of the radius of the projected point in the ideal image plane. The radius of the projected point in the ideal image plane, in turn, depends on the incident angle, as demonstrated in FIGS. 5A and 5B above. This viewpoint shift polynomial enables techniques for calibrating the model and for using the resulting characterization of the fisheye camera for common computer vision and computational imaging tasks. In particular, the viewpoint shift polynomial allows using methods for steps of computing the projection of a point in 3D space to a point in the 2D image and calculating the initial estimate for the calibration parameters without knowing the detailed design specifications of the camera, similar to those for the analogous central model, as described in methods 600 and 700 of FIGS. 6 and 7.

The axial viewpoint shift polynomial allows computing the projection of a point in 3D space to a point in the 2D image with more accuracy and the same complexity. In case of other non-central models computing the position of the projection of a 3D point in the image plane may be more complicated when a non-central model is used than in the case of a central projection. For example, the location of the viewpoint may be unknown. The location of the viewpoint depends on the incident angle but, at the same time, the incident angle depends on the amount by which the axial viewpoint shifts. Therefore, finding the location of the viewpoint and the incident angle may be difficult and may involve an iterative algorithm to find a solution.

As one example, using a central model, the ray in 3D that corresponds to any given image point may be easy to identify because the lens distortion is characterized by the function of the projected point radius. Finding the projection of a 3D point to the 2D image is more difficult and may involve solving a non-linear equation. For example, the projection of a given point (X,Y,Z) in the ideal image plane may be the point (x,y) such that the following equation holds:

(X,Y,Z)=d(x,y,ƒ(ρ)) Eqn. 7

for some d>0 and ρ=\sqrt{x²+y²}. Comparing the individual components and setting R=\sqrt{X²+Y²} results in the Equation:

$$d = \frac{X}{x} = \frac{Y}{y} = \frac{R}{ρ} = \frac{Z}{f ( ρ )} \qquad Eqn . 8$$

The radius ρ may therefore be found using the equation:

$$f ( ρ ) - \frac{Z}{R} ρ = 0 \qquad Eqn . 9$$

After ρ is found by solving this non-linear equation, x and y may be computed as:

$$x = \frac{ρ}{R} X , y = \frac{ρ}{R} Y \qquad Eqn . 10$$

In case of the non-central model with viewpoint shift polynomial, the corresponding ray in 3D for any given point in the captured 2D image also may be easily identified, but computing the projection of the 3D point to the 2D image may be more challenging. However, unlike in case of other non-central camera models that may involve the additional non-trivial step of determining the viewpoint or, equivalently, the incident angle, the complexity of computing the projection from 3D to 2D for the non-central model described herein may be similar to that for a central model.

In various examples, the central model described by Eqn. 7 can be adapted to include the viewpoint shift. For example, instead of Eqn. 7, the non-central camera model described herein may be based on the equation:

(X,Y,Z)=(0,0,g(ρ))+d(x,y,ƒ(ρ)) Eqn. 11

In this case, comparing the components yields the equation:

$$d = \frac{X}{x} = \frac{Y}{y} = \frac{R}{ρ} = \frac{Z - g ( p )}{f ( ρ )} \qquad Eqn . 12$$

In various examples, instead of solving Eqn. 9, ρ is determined by solving an analogous equation:

$$f ( ρ ) - \frac{Z}{R} ρ + \frac{1}{R} g ( ρ ) = 0 \qquad Eqn . 13$$

After ρ is found, x and y may be computed using Eqn. 10 described above. Thus, the projection of a scene point to a point in the fisheye lens image may be easily calculated using the non-central camera model described herein.

In various examples, the non-central camera model may also be used to estimate an initial guess for the calibration parameters. To calibrate the model parameters, some calibration tools use a captured series of images of a checkerboard calibration chart. For example, the calibration chart may be the chart of FIG. 4. The corner points of the squares in the calibration chart are then extracted and used to estimate the camera intrinsic parameters as well as the rotation and translation of the chart with respect to the camera for each calibration image.

To obtain a calibration that is as accurate as possible, a combined reprojection error or some other similar cost function may be minimized via a non-linear optimization method depending on the camera intrinsic and extrinsic parameters. For the algorithm to successfully converge to the optimal solution, an initial guess for the calibration parameters may be within a threshold proximity of the optimum.

Some calibration tools can automatically estimate the initial parameter values and do not require the user to provide detailed design specifications for the camera in a format suitable for the calibration package. In various examples, the algorithm for estimating the initial values of intrinsic and extrinsic parameters proposed in these tools can be adapted to the non-central camera model described herein. This automatic estimation of initial parameter values makes the non-central camera model described herein easy to use for a wide range of users. In various examples, the initial estimate may assume that the mapping from the captured image coordinates to the ideal image plane is trivial and involves only shifting the origin of the coordinate system to the center of the image. Assuming that (x_{j,n}, y_{j,n}), n=1, . . . , N, are all the detected chart corner points in the j-th calibration image after adjusting the origin to the center of the image, then the point (x_{j,n},y_{j,n}) may be the image of the point (Xₙ, Yₙ) on the calibration chart.

In various examples, remaining intrinsic parameters may also be estimated. For example, the remaining intrinsic parameters may be the coefficients of the polynomials ƒ and g that characterize the radial distortion of the lens and the viewpoint shift, respectively. In some examples, the rotation and translation between the camera and each calibration chart position may also be estimated. For example, a set of 3×3 rotation matrices Rⱼ and 3×1 translation vectors tⱼ, j=1, . . . , J, may be generated such that:

$${R}_{j} [ \begin{matrix}{X}_{n} \\ {Y}_{n} \\ 0\end{matrix} ] + {t}_{j} = [ \begin{matrix}0 \\ 0 \\ g ( {ρ}_{j , n} )\end{matrix} ] + {d}_{j , n} [ \begin{matrix}{x}_{j , n} \\ {y}_{j , n} \\ f ( {ρ}_{j , n} )\end{matrix} ] \qquad Eqn . 14$$

where ρ_{j,n}=\sqrt{x_{j,n}²+y_{j,n}²}. On the left side of Eqn. 14, the calibration chart point is converted to the camera coordinate system. On the right side of Eqn. 14, the same point is expressed as some point on the ray corresponding to the detected corner point (x_{j,n},y_{j,n}), as predicted by the intrinsic model. In various examples, to solve for the unknowns, the unknown distance of each point d_{j,n} along the ray can be eliminated by using the cross product. For example, the result may be:

$$( {R}_{j} [ \begin{matrix}{X}_{n} \\ {Y}_{n} \\ 0\end{matrix} ] + {t}_{j} - [ \begin{matrix}0 \\ 0 \\ g ( {ρ}_{j , n} )\end{matrix} ] ) \times [ \begin{matrix}{x}_{j , n} \\ {y}_{j , n} \\ f ( {ρ}_{j , n} )\end{matrix} ] = 0 \qquad Eqn . 15$$

In various examples, given:

$${R}_{j} = [ \begin{matrix}{r}_{11}^{( j )} & {r}_{12}^{( j )} & {r}_{13}^{( j )} \\ {r}_{21}^{( j )} & {r}_{22}^{( j )} & {r}_{23}^{( j )} \\ {r}_{31}^{( j )} & {r}_{32}^{( j )} & {r}_{33}^{( j )}\end{matrix} ] , {t}_{j} = [ \begin{matrix}{t}_{1}^{( j )} \\ {t}_{2}^{( j )} \\ {t}_{3}^{( j )}\end{matrix} ] ,$$

then Eqn. 15 may be written as the equations:

(r₂₁^{(j)}Xₙ+r₂₂^{(j)}Yₙ+t₂^{(j)})ƒ(ρ_{j,n})−(r₃₁^{(j)}Xₙ+r₃₂^{(j)}Yₙ+t₃^{(j)}−g(ρ_{j,n}))y_{j,n}=0 Eqn. 16A

(r₃₁^{(j)}Xₙ+r₃₂^{(j)}Yₙ+t₃^{(j)}−g(ρ_{j,n}))x_{j,n}−(r₁₁^{(j)}Xₙ+r₁₂^{(j)}Yₙ+t₁^{(j)})ƒ(ρ_{j,n})=0 Eqn. 16B

(r₁₁^{(j)}Xₙ+r₁₂^{(j)}Yₙ+t₁^{(j)})y_{j,n}−(r₂₁^{(j)}Xₙ+r₂₂^{(j)}Yₙ+t₂^{(j)})x_{j,n}=0 Eqn. 16C

The last of the three equations, Eqn. 16C, does not involve the unknown values ƒ(ρ_{j,n}) and g(ρ_{j,n}). Collecting these equations for all n=1, . . . , N (i.e., for all the detected corners in a single calibration image), a linear system is formed that can be solved for r₁₁^{(j)}, r₁₂^{(j)}, r₂₁^{(j)}, r₂₂^{(j)}, t₁^{(j)}, and t₂^{(j)}. However, this linear system is overdetermined and homogeneous, and therefore a solution may only be obtained in the least squares sense and up to an unknown scale factor.

Denoting this solution as \tilde{r}₁₁^{(j)}, \tilde{r}₁₂^{(j)}, \tilde{r}₂₁^{(j)}, \tilde{r}₂₂^{(j)}, \tilde{t}₁^{(j)}, and \tilde{t}₂^{(j)} and given:

$$A = [ \begin{matrix}{\tilde{r}}_{11}^{( j )} & {\tilde{r}}_{12}^{( j )} \\ {\tilde{r}}_{21}^{( j )} & {\tilde{r}}_{22}^{( j )}\end{matrix} ] ,$$

to determine all the coefficients of the rotation Rⱼ, 2×1 vectors b, c, and constants s and d may be determined such that the matrix:

$$[ \begin{matrix}s A & b \\ {c}^{T} & d\end{matrix} ]$$

is a rotation. In other words, the matrix is orthogonal and its determinant is equal to 1. In various examples, there are four possible solutions to this completion problem.
They can be found by computing the singular value decomposition of matrix A:

$$A = [ {u}_{1} {u}_{2} ] [ \begin{matrix}{σ}_{1} & 0 \\ 0 & {σ}_{2}\end{matrix} ] [ \begin{matrix}{v}_{1}^{T} \\ {v}_{2}^{T}\end{matrix} ]$$

The scaling factor s is:

$$s = \pm \frac{1}{{σ}_{1}} \qquad Eqn . 17$$

where σ₁ is the larger of the two singular values of A, and:

$$c = \pm \sqrt{1 - ( \frac{{σ}_{2}}{{σ}_{1}} )} {v}_{2} \qquad Eqn . 18$$

where v₂ is the right singular vector of A corresponding to its smaller singular value, σ₂. In some examples, the last column

$$[ \begin{matrix}b \\ d\end{matrix} ]$$

of the completion then can be found by computing the cross product of the first two columns and making sure that det(Rⱼ)=1.

Only one of the four possible completions, however, provides the right rotation matrix Rⱼ. To find the correct sign of s, d_{j,n}>0 may be used for all j and n and the top two rows of Eqn. 14 used to determine the correct sign. To find the correct sign of c, either the last row of Eqn. 14, together with d_{j,n} obtained using the top two rows as suggested above, or Eqns. 16A and 16B, may be used for all n, to calculate temporary estimates for the last missing translation coefficient t₃^{(j)} and the coefficients of the polynomials ƒ and g. With the correct sign of c, ƒ is a decreasing function and ƒ(0)>0.

In various examples, due to the real system not perfectly fitting the assumed model and the noise in the detected calibration chart points, the estimates of ƒ and g may tend to be different for each calibration image j and the estimated values of their coefficients and of t₃^{(j)} and may not be very accurate. In some examples, more accurate values can be obtained by keeping only the produced rotations Rⱼ (using c with the correct sign in each case) and forming one large linear system by collecting the last row of Eqn. 14, or Eqns. 16A and 16B, for all n and j. Solving this single system may produce a much more accurate estimate of the coefficients of the polynomials ƒ and g and of t₃^{(j)}, j=1, . . . , J.

In practice, the parameters obtained in this manner, as they are, may not provide a sufficiently accurate characterization of a fisheye camera that could be directly used in the applications. For example, this may be due to a number of reasons, including the sensor-lens alignment, with the center of distortion (principal point) generally not exactly in the center of the captured image, and often also outliers in the detected calibration chart corner points. However, the estimate may be reliable enough to serve as the starting point for an iterative non-linear optimization, minimizing some appropriate cost function such as the mean square reprojection error, or reprojection error modified to reduce the impact of outliers.

Alternatively, in some examples, the accuracy of the initial estimate can also be improved by splitting the intrinsic and extrinsic parameters into several groups and estimating the parameter values iteratively in an alternating fashion. For example, better values for the parameters in one of the groups may be computed while keeping all the remaining parameters fixed. In various examples, the groups may be chosen in such a way that each of the steps is easy to perform. For example, an iterative process that alternates computing the following values maybe performed: the coordinates of principal point (center of distortion), the extrinsic parameters (rotation and translation coefficients) except for t₃^{(j)}, and the coefficients of the polynomials ƒ and g and translation coefficients t₃^{(j)}, j=1, . . . , J. In various examples, the computation of the last two values may be performed using the same algorithms as described above. For example, the coordinates of the principal point are initialized as the center of the image, and each time after the extrinsic parameters and coefficients and translation coefficients are calculated, the correction to the principal point for each calibration image may be found by computing the mean of (\tilde{x}_{j,n}, \tilde{y}_{j,n})−(x_{j,n}, y_{j,n}), over all n=1, . . . , N and, j=1, . . . , J, where (\tilde{x}_{j,n}, \tilde{y}_{j,n}) are the coordinates of the calibration chart point (Xₙ, Yₙ) projected to the ideal image plane using the current estimates of the coordinate system rotation and translation Rⱼ, tⱼ and the radial distortion and axial viewpoint shift polynomials ƒ and g. This correction may then be used to obtain new, more accurate values of points (x_{j,n}, y_{j,n}) in the ideal image plane corresponding to the test chart corner points detected in the captured images. In various examples, the whole process may then be repeated.

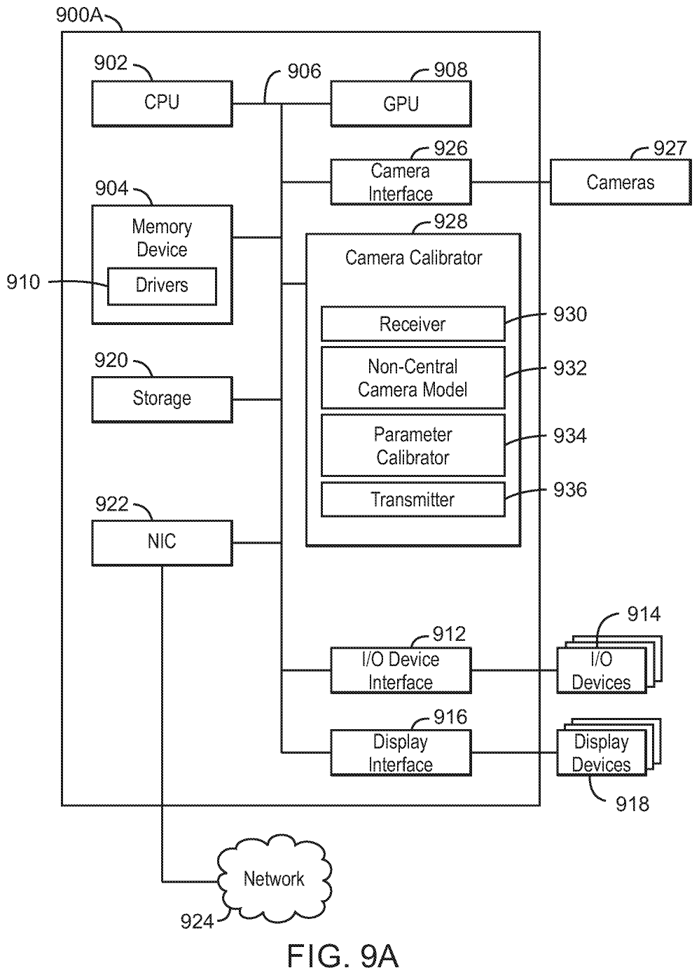

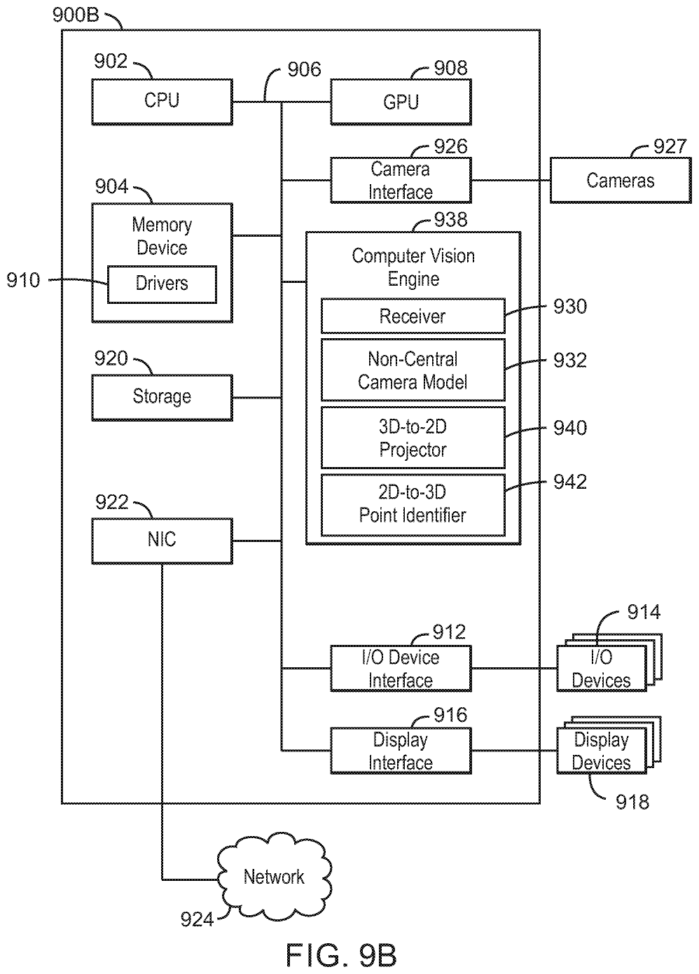

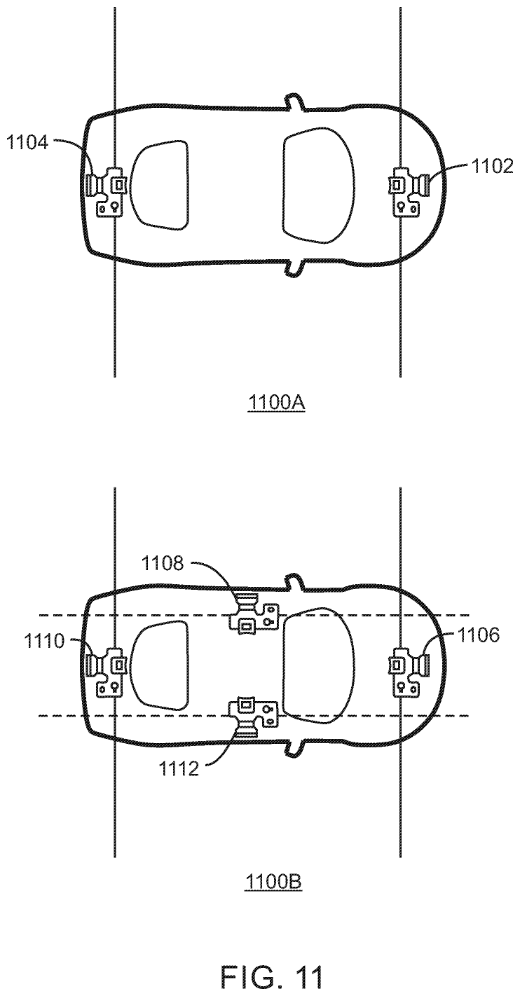

FIG. 6 is a flow chart illustrating a method for calibrating parameters of a non-central camera model augmented with viewpoint shift. The example method 600 can be implemented in the system 100 of FIG. 1, the computing device 900A of FIG. 9A, or the computer readable media 1100 of FIG. 11.

At block 602, a number of images are captured using a camera. For example, the images may be of a calibration chart, such as a checkerboard calibration chart. In some examples, the field of view of a fisheye lens may be too large and cannot be covered with a planar chart in a single position as done with cameras having a smaller FOV. Thus, the calibration chart may be imaged in a number of different positions to cover the entire FOV of the camera. In addition, the capture of more calibration images may result in the availability more points for the calibration. In turn, having more points for calibration may result in a more accurate calibration.

At block 604, a set of calibration parameters is calculated for the camera, where the camera is modeled using a non-central lens model that includes a radial distortion function and a viewpoint shift function including a function of a radius of a projected point in an ideal image plane. In some examples, feature points are detected in the images of the calibration chart. For example, the feature points may be corner points detected using any suitable corner detection technique. The coordinates of the detected feature points may be output. In various examples, an initial set of intrinsic and extrinsic parameters are estimated using the non-central camera model using a shift of an origin system to the center of the number of images. For example, a rotation and a translation between the camera and each calibration chart position may also be estimated using the coordinates of the feature points. In some examples, intrinsic parameters and extrinsic parameters may be split into several groups and the parameter values iteratively estimated. For example, the parameter values can be initially estimated by iteratively computing coordinates of a center of distortion, extrinsic parameters including rotation and a subset of translation coefficients, and coefficients of a radial distortion polynomial and a viewpoint shift polynomial and any remaining translation coefficients. In various examples, a radial distortion and viewpoint shift are estimated based on an estimated rotation and translation between the camera and each of the number of images. For example, a rotation and translation between the camera and a calibration chart position in each of the number of images may be estimated. In various examples, the radial distortion and viewpoint shift may be estimated using Eqns. 14, 15, and 16A-16C above. In some examples, an iterative alternating refinement may be performed. For example, the intrinsic and extrinsic parameters may be split into groups. The parameter values iteratively in an alternating fashion by group. For example, better values for the parameters in one of the groups may be computed while keeping all the remaining parameters fixed. In various examples, the iterative alternating refinement may alternate between computing: the coordinates of principal point (center of distortion), the extrinsic parameters (rotation and translation coefficients) except for some, and the coefficients of the polynomials ƒ and g and remaining translation coefficients. In various examples, an iterative optimization is executed that minimizes a cost function using an estimated radial distortion and viewpoint shift for a non-central camera model as a starting point to generate a set of calibration parameters for the camera. In various examples, the iterative optimization may be a non-linear optimization. For example, the cost function may be a may be a mean square reprojection error, or a reprojection error modified to reduce the impact of outliers.

This process flow diagram is not intended to indicate that all of the blocks of example method 600 are to be included in every case. For example, block 606 may be skipped. Further, any number of additional blocks not shown may be included within the example method 600, depending on the details of the specific implementation. For example, the method 600 may include executing a computer vision task based on the generated set of calibration parameters.

FIG. 7 is a flow chart illustrating a method for computing a 3D-to-2D point projection using a non-central camera model augmented with viewpoint shift. The example method 700 can be implemented in the system 100 of FIG. 1, the computing device 900B of FIG. 9B, or the computer readable media 1100 of FIG. 11.

At block 702, spatial coordinates of 3D points to be projected and a set of calibration parameters are received. For example, the spatial coordinates may correspond to a particular point in the scene surrounding the camera. In various examples, the calibration parameters may be received from a calibration performed using a non-central camera model. For example, the calibration parameters may have been generated using the method 600 of FIG. 6.

At block 704, a projection of points in a three-dimensional (3D) space to a two-dimensional (2D) space are computed using a non-central camera model that includes an axial viewpoint shift function that is a function of the radius of the projected point in an ideal image plane.

At block 706, 2D coordinates of image points corresponding to the spatial coordinates of the 3D points are output. For example, the output coordinates may be used to identify a matching image location, making it possible for the computer vision/computational imaging engine to combine the information extracted from the captured image with some other information (images obtained by different cameras, existing 3D map, etc.).

This process flow diagram is not intended to indicate that the blocks of the example method 700 are to be executed in any particular order, or that all of the blocks are to be included in every case. Further, any number of additional blocks not shown may be included within the example method 700, depending on the details of the specific implementation.

FIG. 8 is a flow chart illustrating a method for a 2D-to-3D point identification using a non-central camera model augmented with viewpoint shift. The example method 800 can be implemented in the system 100 of FIG. 1, the computing device 900B of FIG. 9B, or the computer readable media 1100 of FIG. 11.

At block 802, coordinates of 2D points in an image and a set of calibration parameters are received. For example, the coordinates may correspond to a particular point in an image of a scene surrounding a device including a camera. In various examples, the calibration parameters may be received from a calibration performed using a non-central camera model. For example, the calibration parameters may have been generated using the method 600 of FIG. 6.

At block 804, three-dimensional points in a scene corresponding to 2D points are identified using the calibration parameters and a non-central camera model including an axial viewpoint shift function that is a function of a radius of a projected point in an ideal image plane.

At block 806, a characterization of one or more points in 3D is output. For example, the characterization of the one or more points may use (x,y,z) point coordinates. In some examples, the characterization of the one or more points may use depth information for a given ray direction. In various examples, the characterization of the one or more points may use a description of a ray. For example, the ray may be a line or a line segment that includes points that all project to the same 2D image point.

This process flow diagram is not intended to indicate that the blocks of the example method 800 are to be executed in any particular order, or that all of the blocks are to be included in every case. Further, any number of additional blocks not shown may be included within the example method 800, depending on the details of the specific implementation. For example, aside from various applications in autonomous vehicle navigation used for cars, drones, or robots, other examples of method 800 may include controlling a robot that manipulates objects. For example, the robot may be in a production line. In various examples, the method 800 may include synthesizing different views of a scene. For example, the synthesized views may be used in entertainment, medicine, or security cameras. In some examples, the method 800 may include producing a 3D representation of the scene from captured 2D images for virtual or augmented reality applications. For example, an augmented reality application or virtual reality application may include trying out how furniture you want to buy would look in your living room. In some examples, the method 800 may include using 2D images for taking measurements of the objects in the 3D scene. For example, such measurements may be used in metrology applications. In various examples, the method 800 may include providing an understanding of a 3D the scene including the position of objects in the scene. For example, besides autonomous vehicle navigation, this positioning may be used in security applications, inspection, or medical applications.

Referring now to FIG. 9A, a block diagram is shown illustrating an example computing device that can calibrate cameras using a non-central camera model augmented with axial viewpoint shift. The computing device 900A may be, for example, a laptop computer, desktop computer, tablet computer, mobile device, or wearable device, among others. In some examples, the computing device 900A may be a 3D computer vision system. In various examples, the computing device 900A may be a calibration system used to calibrate the cameras of an autonomous vehicle or a robot. In some examples, the computing device 900A may be a 360 degree image capture system. The computing device 900A may include a central processing unit (CPU) 902 that is configured to execute stored instructions, as well as a memory device 904 that stores instructions that are executable by the CPU 902. The CPU 902 may be coupled to the memory device 904 by a bus 906. Additionally, the CPU 902 can be a single core processor, a multi-core processor, a computing cluster, or any number of other configurations. Furthermore, the computing device 900A may include more than one CPU 902. In some examples, the CPU 902 may be a system-on-chip (SoC) with a multi-core processor architecture. In some examples, the CPU 902 can be a specialized digital signal processor (DSP) used for image processing. The memory device 904 can include random access memory (RAM), read only memory (ROM), flash memory, or any other suitable memory systems. For example, the memory device 904 may include dynamic random access memory (DRAM).

The memory device 904 can include random access memory (RAM), read only memory (ROM), flash memory, or any other suitable memory systems. For example, the memory device 904 may include dynamic random access memory (DRAM).

The computing device 900A may also include a graphics processing unit (GPU) 908. As shown, the CPU 902 may be coupled through the bus 906 to the GPU 908. The GPU 908 may be configured to perform any number of graphics operations within the computing device 900A. For example, the GPU 908 may be configured to render or manipulate graphics images, graphics frames, videos, or the like, to be displayed to a user of the computing device 900A.

The memory device 904 can include random access memory (RAM), read only memory (ROM), flash memory, or any other suitable memory systems. For example, the memory device 904 may include dynamic random access memory (DRAM). The memory device 904 may include device drivers 910 that are configured to execute the instructions for training multiple convolutional neural networks to perform sequence independent processing. The device drivers 910 may be software, an application program, application code, or the like.

The CPU 902 may also be connected through the bus 906 to an input/output (I/O) device interface 912 configured to connect the computing device 900A to one or more I/O devices 914. The I/O devices 914 may include, for example, a keyboard and a pointing device, wherein the pointing device may include a touchpad or a touchscreen, among others. The I/O devices 914 may be built-in components of the computing device 900A, or may be devices that are externally connected to the computing device 900A. In some examples, the memory 904 may be communicatively coupled to I/O devices 914 through direct memory access (DMA).

The CPU 902 may also be linked through the bus 906 to a display interface 916 configured to connect the computing device 900A to a display device 918. The display device 918 may include a display screen that is a built-in component of the computing device 900A. The display device 918 may also include a computer monitor, television, or projector, among others, that is internal to or externally connected to the computing device 900A.

The computing device 900A also includes a storage device 920. The storage device 920 is a physical memory such as a hard drive, an optical drive, a thumbdrive, an array of drives, a solid-state drive, or any combinations thereof. The storage device 920 may also include remote storage drives.

The computing device 900A may also include a network interface controller (NIC) 922. The NIC 922 may be configured to connect the computing device 900A through the bus 906 to a network 924. The network 924 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 600 further includes a camera interface 926. For example, the camera interface 626 may be connected to a number of cameras 927. In some examples, the cameras 927 may include wide angle lenses, ultra-wide angle lenses, fisheye lenses, or any combination thereof. In various examples, the cameras 927 may be omnidirectional cameras. In some examples, the cameras 927 may include catadioptric optics. In some examples, the cameras 927 may include a processor to generate video frames or three dimensional images. In various examples, each of the cameras 927 can be calibrated using the techniques described herein.

The computing device 900A further includes a camera calibrator 928. For example, the fisheye camera modeler and calibrator 928 can be used to model and calibrate a fisheye camera. The camera calibrator 928 can include an image receiver 930, non-central camera model 932, and a parameter calibrator 934, and a transmitter 936. In some examples, each of the components 930-936 of the camera calibrator 928 may be a microcontroller, embedded processor, or software module.

The image receiver 930 can receive a number of images from one or more cameras 927. For example, the cameras 927 may include fisheye lenses. In some examples, the receiver 930 can estimate intrinsic and extrinsic parameters for each camera. In various examples, the receiver 930 can also estimate additional extrinsic parameters representing the mutual position of the cameras. For example, the receiver 930 can estimate rotation and translation between the cameras or with respect to any suitable frame of reference.

The non-central camera model 932 can be used to model the camera using a non-central camera model augmented with an axial viewpoint shift. For example, the non-central camera model may include a radial distortion function and an axial viewpoint shift function. In some examples, the axial viewpoint shift function characterizes the amount of viewpoint shift along an optical axis of the fisheye lens. In various examples, the axial viewpoint shift function includes a function of a radius of a projected point in an ideal image plane. In some examples, the non-central camera model includes a non-redundant six-parameter projective transform that models the projection from ideal image plane to sensor. In various examples, the radial distortion function and an axial viewpoint shift function may each be an even function. In some examples, the radial distortion function and the axial viewpoint shift function may each be polynomials.

The parameter calibrator 934 can calculate a set of calibration parameters for the camera via an iterative optimization of a cost function. For example, the optimization may be a non-linear optimization. In some examples, the parameter calibrator 934 can automatically estimate initial values for the calibration parameters by shifting the origin of a coordinate system to a center of the image. In various examples, the parameter calibrator 934 can estimate coefficients of the radial distortion function and an axial viewpoint shift parameter based on an estimated rotation and translation between the camera and a calibration chart position in each of the number of images.

The transmitter 936 can transmit the generated calibration parameters to another computing device, such as a robot or an autonomous vehicle. For example, the calibration parameters may be transmitted to the computing device 900B of FIG. 9B. In various examples, the generated calibration parameters may be used to determine the position of the robot or the autonomous vehicle.

The block diagram of FIG. 9A is not intended to indicate that the computing device 900A is to include all of the components shown in FIG. 9A. Rather, the computing device 900A can include fewer or additional components not illustrated in FIG. 9A, such as additional buffers, additional processors, and the like. The computing device 900A may include any number of additional components not shown in FIG. 9A, depending on the details of the specific implementation. Furthermore, any of the functionalities of the image receiver 930, the non-central camera model 932, the parameter calibrator 934, and the transmitter 936, may be partially, or entirely, implemented in hardware and/or in the processor 902. For example, the functionality may be implemented with an application specific integrated circuit, in logic implemented in the processor 902, or in any other device. In addition, any of the functionalities of the CPU 902 may be partially, or entirely, implemented in hardware and/or in a processor. For example, the functionality of the image receiver 930, the non-central camera model 932, and the parameter calibrator 934, and the transmitter 936, may be implemented with an application specific integrated circuit, in logic implemented in a processor, in logic implemented in a specialized graphics processing unit such as the GPU 908, or in any other device.

FIG. 9B is a block diagram illustrating an example computing device that can compute 3D-to-2D point projections and 2D-to-3D point identifications using a non-central camera model augmented with axial viewpoint shift. The computing device 900B includes similarly numbered elements of computing device 900A of FIG. 9A. In various examples, the computing device 900B may be an autonomous vehicle, such as a car, a drone, or a robot. In some examples, the computing device 900B may be a controlling robot that manipulates objects, such as those used in a production line. In various examples, the computing device 900B may be a camera system, such as a camera used for entertainment, medicine, or security applications.

In addition, computing device 900B includes a computer vision engine 938. For example, the computer vision engine 938 can perform one or more computer vision tasks or computational imaging tasks. In some examples, the computer vision engine 938 can receive images from the cameras 927 and calibration parameters and uses the non-central camera model 932 to perform various computer vision or computational imaging tasks. For example, these tasks may include synthesizing other images such as projections, creating a 3D map of a scene that can be used for navigation, detecting and classifying objects in the scene, etc. The computer vision engine 938 can include a receiver 930, a non-central camera model 932, a 3d-to-2D projector 940, and a 2D-to-3D point identifier 942. In some examples, each of the components 930, 932, 940, and 942 of the computer vision engine 938 may be a microcontroller, embedded processor, or software module.

The 3D-to-2D projector 940 can project points in 3D space to points in a 2D image using a non-central camera model that comprises an axial viewpoint shift function that is a function of the radius of the projected point in an ideal image plane. In various examples, the non-central camera model comprises a non-redundant six-parameter projective transform. In some examples, the axial viewpoint shift function may be an even function. In various examples, the axial viewpoint shift function may be a polynomial. In some examples, the 3D-to-2D projector 940 can project points in 3D space to points in a 2D image based on calibrated parameters corresponding to the axial viewpoint shift function. For example, the 3D-to-2D projector 940 can project the points in 3D space to points in the 2D image based on the calibration parameters including the parameters for a radial distortion function and the axial viewpoint shift function. In various examples, the 3D-to-2D projector 940 can output 2D coordinates of image points corresponding to the spatial coordinates of the points in the 3D space. In various examples, the 2D-to-3D point identifier 942 can determine one or more points in 3D space that correspond to a point in a 2D image based on the calibration parameters. For example, the 2D-to-3D point identifier 942 can determine one or more points in 3D space that correspond to a point in a 2D image based on calibration parameters including parameters for an axial viewpoint shift function and a radial distortion function of the non-central camera model 932. In various examples, the 2D-to-3D point identifier 942 can output a characterization of one or more 3D points. For example, the characterization may include a set of coordinates, depth information for a given ray direction, or a description of a ray.

The block diagram of FIG. 9B is not intended to indicate that the computing device 900B is to include all of the components shown in FIG. 9B. Rather, the computing device 900B can include fewer or additional components not illustrated in FIG. 9B, such as additional buffers, additional processors, and the like. The computing device 900B may include any number of additional components not shown in FIG. 9B, depending on the details of the specific implementation. Furthermore, any of the functionalities of the image receiver 930, the non-central camera model 932, the 3D-to-2D projector 940, and the 2D-to-3D point identifier 942, may be partially, or entirely, implemented in hardware and/or in the processor 902. For example, the functionality may be implemented with an application specific integrated circuit, in logic implemented in the processor 902, or in any other device. In addition, any of the functionalities of the CPU 902 may be partially, or entirely, implemented in hardware and/or in a processor. For example, the functionality of the image receiver 930, the non-central camera model 932, the 3D-to-2D projector 940, and the 2D-to-3D point identifier 942, may be implemented with an application specific integrated circuit, in logic implemented in a processor, in logic implemented in a specialized graphics processing unit such as the GPU 908, or in any other device.

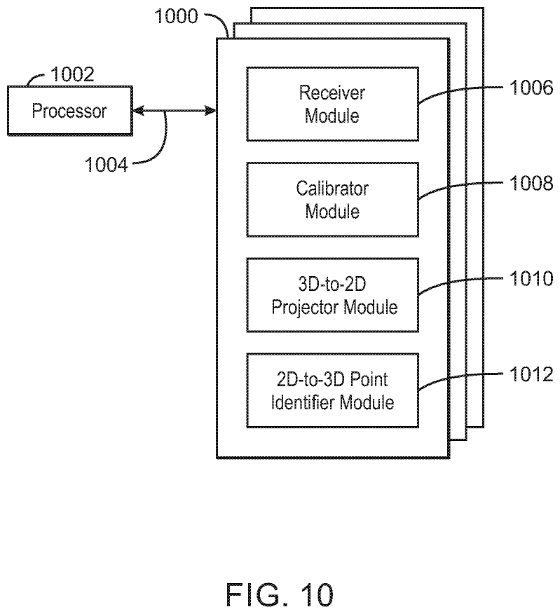

FIG. 10 is a block diagram showing computer readable media 1000 that store code for calibrating and computing point projections for cameras using a non-central camera model augmented with axial viewpoint shift. The computer readable media 1000 may be accessed by a processor 1002 over a computer bus 1004. Furthermore, the computer readable medium 1000 may include code configured to direct the processor 1002 to perform the methods described herein. In some embodiments, the computer readable media 1000 may be non-transitory computer readable media. In some examples, the computer readable media 1000 may be storage media.

The various software components discussed herein may be stored on one or more computer readable media 1000, as indicated in FIG. 10. For example, an image receiver module 1006 may be configured to receive images from one or more cameras. In some examples, the images may be of a calibration chart, such as a checkerboard calibration chart. In some examples, the images may be of a scene. For example, the scene may be a surrounding area of a robot or an autonomous vehicle fitted with the fisheye camera or cameras. A calibrator module 1008 may be configured to calculate a set of calibration parameters is calculated for the camera, where the camera is modeled using a non-central lens model that includes a radial distortion function and a viewpoint shift function including a function of a radius of a projected point in an ideal image plane. For example, the calibrator module 1008 may be configured to execute an iterative non-linear optimization that minimizes a cost function using an estimated radial distortion and axial viewpoint shift for a non-central camera model as a starting point to generate a set of calibration parameters for the camera. For example, the calibrator module 1008 may be configured to estimate an initial set of intrinsic and extrinsic parameters using the non-central camera model using a shift of an origin system to the center of the image. In some examples, the calibrator module 1008 may be configured to estimate a rotation and a translation between the camera and each calibration chart position. In various examples, the calibrator module 1008 may be configured to estimate the radial distortion and axial viewpoint shift based on an estimated rotation and translation between the camera and each calibration chart position in the number of images. In some examples, the calibrator module 1008 may be configured to split intrinsic and extrinsic parameters into several groups and iteratively estimate the parameter values. In various examples, the calibrator module 1008 may be configured to initially estimate the parameter values by iteratively computing coordinates of a center of distortion, extrinsic parameters including rotation and a subset of translation coefficients, and coefficients of a radial distortion polynomial and an axial viewpoint shift polynomial and any remaining translation coefficients. A 3D-to-2D projector module 1010 may be configured to execute computer vision tasks based on received calibration parameters and images. For example, the 3D-to-2D projector module 1010 may be configured to project points in 3D space to points in a 2D image based on calibration parameters corresponding to the axial viewpoint shift polynomial. In some examples, the 3D-to-2D projector module 1010 may be configured to receive input coordinates of a 3D point and the calibration parameters produced by the calibrator module 1008 and compute a projection of points in a three-dimensional (3D) space to a two-dimensional (2D) space using a non-central camera model that expresses an amount of shift of axial viewpoint along an optical axis as a function of the radius of the projected point in an ideal image plane. A 2D-to-3D point identifier module 1012 may be configured to determine one or more points in 3D space that correspond to a point in a 2D image based on the calibration parameters. For example, the points in 3D space may be output in a characterization that includes a set of coordinates. In some examples, a characterization of the one or more points in 3D space may include depth information for a given ray direction. In various examples, the characterization of the one or more points may include a description of a ray. For example, the ray may be a line or a line segment that includes points that all project to the same 2D image point.

The block diagram of FIG. 10 is not intended to indicate that the computer readable media 1000 is to include all of the components shown in FIG. 10. Further, the computer readable media 1000 may include any number of additional components not shown in FIG. 10, depending on the details of the specific implementation. For example, the computer readable media 1000 may include a transmitter module to transmitting a projection of the image to a display. In some examples, the transmitter module may be configured to transmit the calibration parameters to a robot or an autonomous vehicle. For example, the calibration parameters may be used to determine the position of the robot or the autonomous vehicle.

FIG. 11 is an illustration of vehicles 1100A and 1100B with fisheye cameras. Vehicle 1100A includes two fisheye cameras 1102 and 1104. Vehicle 1100B includes four fisheye cameras 1106, 1108, 1110, and 1112. While a particular number of cameras are illustrated, vehicles 1100A and 1100B may include any number of fisheye cameras, at any position along the surface, within, or underneath the vehicles 1100A and 1100B. Further, vehicles 1100A and 1100B may include system 100 and a non-central camera model for lens distortion or the computing device 104 as described by FIG. 1. Further, the vehicles 1100A and 1100B are able to implement the methods 700 and 800 of FIGS. 7 and 8, respectively.

As illustrated, vehicle 1100A may capture a scene from the environment including various objects. Each of the fisheye cameras 1102 and 1104 can capture up to a one-hundred and eighty-degree field of view (FOV). Similarly, vehicle 1100B may capture a scene from the environment including various objects. Each of the fisheye cameras 1106, 1108, 1110, and 1112 can capture up to a one hundred and eighty-degree FOV. Here, the various FOVs overlap. The present techniques enable a processor to map points in captured 2D images from the cameras 1102, 1104, 1106, 1108, 1110, and 1112 to light rays and/or points in 3D world and vice versa via efficient camera calibration. For example, the processor can generate different kinds of images, 3D maps, or any other suitable information using calibration parameters estimated using a non-central camera model. The calibration enables the vehicles to quickly determine their location within an environment.

### Examples

Example 1 is a system for identification of three-dimensional points. The system includes a receiver to receive coordinates of a two-dimensional point in an image, and a set of calibration parameters. The system also includes a 2D-to-3D point identifier to identify a three-dimensional point in a scene corresponding to the 2D point using the calibration parameters and a non-central camera model including an axial viewpoint shift function including a function of a radius of a projected point in an ideal image plane.

Example 2 includes the system of example 1, including or excluding optional features. In this example, the system includes a camera to capture the image.

Example 3 includes the system of any one of examples 1 to 2, including or excluding optional features. In this example, the non-central camera model includes a non-redundant six-parameter projective transform.

Example 4 includes the system of any one of examples 1 to 3, including or excluding optional features. In this example, the axial viewpoint shift function includes an even function.

Example 5 includes the system of any one of examples 1 to 4, including or excluding optional features. In this example, the axial viewpoint shift function includes a polynomial.

Example 6 includes the system of any one of examples 1 to 5, including or excluding optional features. In this example, the system includes a set of coordinates.

Example 7 includes the system of any one of examples 1 to 6, including or excluding optional features. In this example, the 2D-to-3D point identifier is to output a characterization of the 3D point including depth information for a given ray direction.

Example 8 includes the system of any one of examples 1 to 7, including or excluding optional features. In this example, the 2D-to-3D point identifier is to output a characterization of the 3D point including a description of a ray.

Example 9 includes the system of any one of examples 1 to 8, including or excluding optional features. In this example, the non-central camera model includes a radial distortion function.

Example 10 includes the system of any one of examples 1 to 9, including or excluding optional features. In this example, the system includes an autonomous vehicle, wherein the three-dimensional point is used to determine the position of the autonomous vehicle.

Example 11 is a system for projection of three-dimensional points. The system includes a receiver to receive spatial coordinates of three-dimensional (3D) points to be projected, and a set of calibration parameters. The system also includes a 3D-to-2D projector to compute a projection of points in a three-dimensional (3D) space to a two-dimensional (2D) image using a non-central camera model including an axial viewpoint function that is a function of the radius of the projected point in an ideal image plane.

Example 12 includes the system of example 11, including or excluding optional features. In this example, the system includes a camera to capture the 2D image.

Example 13 includes the system of any one of examples 11 to 12, including or excluding optional features. In this example, the non-central camera model includes a non-redundant six-parameter projective transform.

Example 14 includes the system of any one of examples 11 to 13, including or excluding optional features. In this example, the axial viewpoint shift function includes an even function.

Example 15 includes the system of any one of examples 11 to 14, including or excluding optional features. In this example, the axial viewpoint shift function includes a polynomial.

Example 16 includes the system of any one of examples 11 to 15, including or excluding optional features. In this example, the non-central camera model includes a radial distortion function.

Example 17 includes the system of any one of examples 11 to 16, including or excluding optional features. In this example, the 3D-to-2D projector is to output 2D coordinates of image points corresponding to the spatial coordinates of the points in the 3D space.

Example 18 includes the system of any one of examples 11 to 17, including or excluding optional features. In this example, the non-central camera model includes an even radial distortion function.

Example 19 includes the system of any one of examples 11 to 18, including or excluding optional features. In this example, the non-central camera model includes a radial distortion function including a polynomial.

Example 20 includes the system of any one of examples 11 to 19, including or excluding optional features. In this example, the system includes a robot or an autonomous vehicle.

Example 21 is at least one computer readable medium for calibrating cameras having instructions stored therein that direct the processor to receive images from a camera. The computer-readable medium also includes instructions that direct the processor to calculate a set of calibration parameters is calculated for the camera. The camera is modeled using a non-central lens model that includes a radial distortion function and a viewpoint shift function including a function of a radius of a projected point in an ideal image plane.

Example 22 includes the computer-readable medium of example 21, including or excluding optional features. In this example, the computer-readable medium includes instructions to execute an iterative non-linear optimization that minimizes a cost function using an estimated radial distortion and axial viewpoint shift for a non-central camera model as a starting point to generate a set of calibration parameters for the camera.

Example 23 includes the computer-readable medium of any one of examples 21 to 22, including or excluding optional features. In this example, the computer-readable medium includes instructions to estimate an initial set of intrinsic and extrinsic parameters using the non-central camera model using a shift of an origin system to the center of the image.

Example 24 includes the computer-readable medium of any one of examples 21 to 23, including or excluding optional features. In this example, the computer-readable medium includes instructions to split intrinsic and extrinsic parameters into several groups and iteratively estimate the parameter values.

Example 25 includes the computer-readable medium of any one of examples 21 to 24, including or excluding optional features. In this example, the computer-readable medium includes instructions to initially estimate the parameter values by iteratively computing coordinates of a center of distortion, extrinsic parameters including rotation and a subset of translation coefficients, and coefficients of a radial distortion polynomial and an axial viewpoint shift polynomial and any remaining translation coefficients.

Example 26 includes the computer-readable medium of any one of examples 21 to 25, including or excluding optional features. In this example, the computer-readable medium includes instructions to project points in 3D space to points in a 2D image based on calibration parameters corresponding to the axial viewpoint shift polynomial.

Example 27 includes the computer-readable medium of any one of examples 21 to 26, including or excluding optional features. In this example, the computer-readable medium includes instructions to receive input coordinates of a 3D point and the calibration parameters and compute a projection of points in a three-dimensional (3D) space to a two-dimensional (2D) space using the non-central camera model.

Example 28 includes the computer-readable medium of any one of examples 21 to 27, including or excluding optional features. In this example, the computer-readable medium includes instructions to determine one or more points in 3D space that correspond to a point in a 2D image based on the calibration parameters.

Example 29 includes the computer-readable medium of any one of examples 21 to 28, including or excluding optional features. In this example, the computer-readable medium includes instructions to output a characterization of a point in 3D space including depth information for a given ray direction or a description of a ray.

Example 30 includes the computer-readable medium of any one of examples 21 to 29, including or excluding optional features. In this example, the computer-readable medium includes instructions to output a characterization of a point in 3D space including a set of spatial coordinates.

Example 31 is a system for identification of three-dimensional points. The system includes means for receiving coordinates of a two-dimensional point in an image, and a set of calibration parameters. The system also includes means for identifying a three-dimensional point in a scene corresponding to the 2D point using the calibration parameters and a non-central camera model including an axial viewpoint shift function including a function of a radius of a projected point in an ideal image plane.

Example 32 includes the system of example 31, including or excluding optional features. In this example, the system includes means for capturing the image.

Example 33 includes the system of any one of examples 31 to 32, including or excluding optional features. In this example, the non-central camera model includes a non-redundant six-parameter projective transform.

Example 34 includes the system of any one of examples 31 to 33, including or excluding optional features. In this example, the axial viewpoint shift function includes an even function.

Example 35 includes the system of any one of examples 31 to 34, including or excluding optional features. In this example, the axial viewpoint shift function includes a polynomial.

Example 36 includes the system of any one of examples 31 to 35, including or excluding optional features. In this example, the system includes a set of coordinates.

Example 37 includes the system of any one of examples 31 to 36, including or excluding optional features. In this example, the means for identifying the three-dimensional point is to output a characterization of the 3D point including depth information for a given ray direction.

Example 38 includes the system of any one of examples 31 to 37, including or excluding optional features. In this example, means for identifying the three-dimensional point is to output a characterization of the 3D point including a description of a ray.

Example 39 includes the system of any one of examples 31 to 38, including or excluding optional features. In this example, the non-central camera model includes a radial distortion function.

Example 40 includes the system of any one of examples 31 to 39, including or excluding optional features. In this example, the system includes an autonomous vehicle, wherein the three-dimensional point is used to determine the position of the autonomous vehicle.

Example 41 is a system for projection of three-dimensional points. The system includes means for receiving spatial coordinates of three-dimensional (3D) points to be projected, and a set of calibration parameters. The system also includes means for computing a projection of points in a three-dimensional (3D) space to a two-dimensional (2D) image using a non-central camera model including an axial viewpoint function that is a function of the radius of the projected point in an ideal image plane.

Example 42 includes the system of example 41, including or excluding optional features. In this example, the system includes means for capturing the 2D image.

Example 43 includes the system of any one of examples 41 to 42, including or excluding optional features. In this example, the non-central camera model includes a non-redundant six-parameter projective transform.

Example 44 includes the system of any one of examples 41 to 43, including or excluding optional features. In this example, the axial viewpoint shift function includes an even function.

Example 45 includes the system of any one of examples 41 to 44, including or excluding optional features. In this example, the axial viewpoint shift function includes a polynomial.

Example 46 includes the system of any one of examples 41 to 45, including or excluding optional features. In this example, the non-central camera model includes a radial distortion function.

Example 47 includes the system of any one of examples 41 to 46, including or excluding optional features. In this example, the means for computing the projection is to output 2D coordinates of image points corresponding to the spatial coordinates of the points in the 3D space.

Example 48 includes the system of any one of examples 41 to 47, including or excluding optional features. In this example, the non-central camera model includes an even radial distortion function.

Example 49 includes the system of any one of examples 41 to 48, including or excluding optional features. In this example, the non-central camera model includes a radial distortion function including a polynomial.

Example 50 includes the system of any one of examples 41 to 49, including or excluding optional features. In this example, the system includes a robot or an autonomous vehicle.

Example 51 is a method for calibrating cameras. The method includes receiving, via a processor, a number of images captured using a camera. The method also includes calculating, via the processor, a set of calibration parameters for the camera. The camera is modeled using a non-central lens model including an axial viewpoint shift function including a function of a radius of a projected point in an ideal image plane.

Example 52 includes the method of example 51, including or excluding optional features. In this example, calculating the set of calibration parameters includes detecting feature points in the number of images, wherein the number of images include images of a calibration chart.

Example 53 includes the method of any one of examples 51 to 52, including or excluding optional features. In this example, calculating the set of calibration parameters includes estimating an initial set of intrinsic and extrinsic parameters using the non-central camera model using a shift of an origin system to the center of the number of images.

Example 54 includes the method of any one of examples 51 to 53, including or excluding optional features. In this example, calculating the set of calibration parameters includes executing an iterative optimization that minimizes a cost function using an estimated radial distortion and viewpoint shift for the non-central camera model as a starting point to generate the set of calibration parameters for the camera.

Example 55 includes the method of any one of examples 51 to 54, including or excluding optional features. In this example, calculating the set of calibration parameters includes executing a non-linear optimization.

Example 56 includes the method of any one of examples 51 to 55, including or excluding optional features. In this example, calculating the set of calibration parameters includes estimating a rotation and translation between the camera and a calibration chart position in each of the number of images.

Example 57 includes the method of any one of examples 51 to 56, including or excluding optional features. In this example, calculating the set of calibration parameters includes splitting intrinsic parameters and extrinsic parameters into groups and iteratively estimating the parameter values.

Example 58 includes the method of any one of examples 51 to 57, including or excluding optional features. In this example, calculating the set of calibration parameters includes iteratively computing: coordinates of a center of distortion; extrinsic parameters including rotation and a subset of translation coefficients; and coefficients of a radial distortion polynomial and an axial viewpoint shift polynomial and any remaining translation coefficients.

Example 59 includes the method of any one of examples 51 to 58, including or excluding optional features. In this example, the non-central camera lens model further includes a radial distortion function.

Example 60 includes the method of any one of examples 51 to 59, including or excluding optional features. In this example, the number of images include images of a calibration chart.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system for identification of three-dimensional (3D) points, comprising:
a receiver to receive coordinates of a two-dimensional (2D) point in an image, and a set of calibration parameters; and
a 2D-to-3D point identifier to identify a three-dimensional point in a scene corresponding to the 2D point using the calibration parameters and a non-central camera model comprising an axial viewpoint shift function comprising a function of a radius of a projected point in an ideal image plane.

2. The system of claim 1, comprising a camera to capture the image.

3. The system of claim 1, wherein the non-central camera model comprises a non-redundant six-parameter projective transform.

4. The system of claim 1, wherein the axial viewpoint shift function comprises an even function.

5. The system of claim 1, wherein the axial viewpoint shift function comprises a polynomial.

6. The system of claim 1, where the 2D-to-3D point identifier is to output a characterization of the 3D point comprising a set of coordinates.

7. The system of claim 1, wherein the 2D-to-3D point identifier is to output a characterization of the 3D point comprising depth information for a given ray direction.

8. The system of claim 1, wherein the 2D-to-3D point identifier is to output a characterization of the 3D point comprising a description of a ray.

9. The system of claim 1, wherein the system comprises a camera system.

10. The system of claim 1, wherein the system comprises an autonomous vehicle, wherein the three-dimensional point is used to determine the position of the autonomous vehicle.

11. A system for projection of three-dimensional (3D) points, comprising:
a receiver to receive spatial coordinates of 3D points to be projected, and a set of calibration parameters; and
a 3D-to-2D projector to compute a projection of points in a three-dimensional (3D) space to a two-dimensional (2D) image using a non-central camera model that comprises an axial viewpoint shift function that is a function of the radius of the projected point in an ideal image plane.

12. The system of claim 11, comprising a camera to capture the 2D image.

13. The system of claim 11, wherein the non-central camera model comprises a non-redundant six-parameter projective transform.

14. The system of claim 11, wherein the axial viewpoint shift function comprises an even function.

15. The system of claim 11, wherein the axial viewpoint shift function comprises a polynomial.

16. The system of claim 11, wherein the system comprises a robot or an autonomous vehicle.

17. The system of claim 11, wherein the 3D-to-2D projector is to output 2D coordinates of image points corresponding to the spatial coordinates of the points in the 3D space.

18. A method for calibrating cameras, comprising:
receiving, via a processor, a plurality of images captured using a camera; and
calculating, via the processor, a set of calibration parameters for the camera, wherein the camera is modeled using a non-central lens model comprising a viewpoint shift function comprising a function of a radius of a projected point in an ideal image plane.

19. The method of claim 18, wherein calculating the set of calibration parameters comprises detecting feature points in the plurality of images, wherein the plurality of images comprise images of a calibration chart.

20. The method of claim 18, wherein calculating the set of calibration parameters comprises estimating an initial set of intrinsic and extrinsic parameters using the non-central camera model using a shift of an origin system to the center of the plurality of images.

21. The method of claim 18, wherein calculating the set of calibration parameters comprises executing an iterative optimization that minimizes a cost function using an estimated radial distortion and viewpoint shift for the non-central camera model as a starting point to generate the set of calibration parameters for the camera.

22. The method of claim 18, wherein calculating the set of calibration parameters comprises executing a non-linear optimization.

23. The method of claim 18, wherein calculating the set of calibration parameters comprises estimating a rotation and translation between the camera and a calibration chart position in each of the plurality of images.

24. The method of claim 18, wherein calculating the set of calibration parameters comprises splitting intrinsic parameters and extrinsic parameters into groups and iteratively estimating the parameter values.

25. The method of claim 18, wherein calculating the set of calibration parameters comprises iteratively computing:
coordinates of a center of distortion;
extrinsic parameters comprising rotation and a subset of translation coefficients; and
coefficients of a radial distortion polynomial and an axial viewpoint shift polynomial and any remaining translation coefficients.
